(19) United States
(12) Patent Application Publication
(10) Pub. No.: US 2024/0030723 A1
(43) Pub. Date: Jan. 25, 2024

(54) EQUALIZATION DEVICE

(71) Applicant: DENSO CORPORATION, Kariya-city (JP)

(72) Inventors: Taisuke KURACHI, Kariya-city (JP); Masaki UCHIYAMA, Kariya-city (JP)

(73) Assignee: DENSO CORPORATION, Kariya-city (JP)

(21) Appl. No.: 18/375,739

(22) Filed: Oct. 2, 2023

Related U.S. Application Data
(63) Continuation of application No. PCT/JP2022/008840, filed on Mar. 2, 2022.

(30) Foreign Application Priority Data
Apr. 2, 2021 (JP) 2021-063719

(51) Int. Cl. H02J 7/00

(52) U.S. Cl. CPC H02J 7/0016; H02J 7/005; H02J 7/007182; H02J 7/007194

(57) ABSTRACT

An equalization device performs equalization of amounts of charge of cell batteries in a battery pack. The device includes a state determination unit that determines whether it is in a predetermined charging state that includes at least one of a state in which the battery pack is subjected to constant current charge and a state in which the battery pack is subjected to constant power charge and does not include a state in which the battery pack is subjected to constant voltage charge, a charging time variation determination unit that determines whether a variation voltage indicating variation of a voltage of each of the cell batteries is higher than a predetermined charging time determination voltage, and a charging time equalization unit that performs the equalization if it is determined that it is in the predetermined charging state and that the variation voltage is higher than the charging time determination voltage.

### CROSS-REFERENCE TO RELATED APPLICATION

The present application is based on and claims the benefit of priority from earlier Japanese Patent Application No. 2021-063719 filed on Apr. 2, 2021, the description of which is incorporated herein by reference.

### BACKGROUND

### Technical Field

The present disclosure relates to an equalization device provided to a battery pack.

### Related Art

Equalization devices perform equalization of the amounts of charge of a plurality of cell batteries included in a battery pack.

### SUMMARY

An aspect of the present disclosure provides an equalization device that performs equalization of amounts of charge of a plurality of cell batteries included in a battery pack, the device including: a state determination unit that determines whether it is in a predetermined charging state that includes at least one of a state in which the battery pack is subjected to constant current charge and a state in which the battery pack is subjected to constant power charge and does not include a state in which the battery pack is subjected to constant voltage charge; a charging time variation determination unit that determines whether a variation voltage indicating a variation of a voltage of each of the cell batteries is higher than a predetermined charging time determination voltage; and a charging time equalization unit that performs the equalization if it is determined that it is in the predetermined charging state and that the variation voltage is higher than the charging time determination voltage.

### BRIEF DESCRIPTION OF THE DRAWINGS

In the accompanying drawings:

FIG. 1 is a circuit diagram illustrating an equalization device and peripheral units thereof according to a first embodiment;

FIG. 2 is a graph illustrating changes of voltage and current of a battery pack during a charging period and after charging;

FIG. 3 is a graph illustrating changes of voltage and current during a main power supply on time period and after the period;

FIG. 4 is a block diagram illustrating a control unit and peripheral units thereof;

FIG. 5 is a flowchart illustrating first to three equalization controls and the like;

FIG. 6 is a block diagram illustrating a control unit and peripheral units thereof according to a second embodiment;

FIG. 7 is a block diagram illustrating a control unit and peripheral units thereof according to a third embodiment; and

FIG. 8 is a block diagram illustrating a control unit and peripheral units thereof according to a fourth embodiment.

### DETAILED DESCRIPTION OF THE PREFERRED EMBODIMENTS

Equalization devices perform equalization of the amounts of charge of a plurality of cell batteries included in a battery pack. For example, JP-A-2018-125977 disclose such a technique.

During charging time of the battery pack, a charging current flows from the positive electrode side to the negative electrode side in each of the cell batteries. Hence, voltage across terminals of each of the cell batteries increases by internal resistance*charging current. Hereinafter, the increase in the voltage across terminals is referred to as charging polarization. The charging polarization in each of the cell batteries does not stabilize immediately even when charging the battery pack is completed. This is because capacitive components such as a parasitic capacitance are present in parallel with at least part of the internal resistance, and a long time period is required to discharge electric charge stored in the capacitive components.

In contrast, when electrical power of the battery pack is used (discharging time), a charging current flows from the negative electrode side to the positive electrode side in each of the cell batteries. Hence, voltage across terminals of each of the cell batteries decreases by internal resistance*working current. Hereinafter, the decrease in voltage across terminals is referred to as working polarization. The working polarization in each of the cell batteries does not stabilize immediately even when using electrical power of the battery pack is completed. This is because, as in the case after charging is completed, a long time period is required to discharge electric charge stored in capacitive components.

Hereinafter, the charging polarization and the working polarization are collectively and simply referred to as polarization. From the above, typically, an equalization time period for the amounts of charge of the cell batteries is limited to a time period after the polarization is canceled. This is because voltages of the cell batteries cannot be correctly determined until the polarization stabilizes.

However, in the battery pack, since self-discharge typically increases as the capacity becomes higher, variation in the amount of charge also easily becomes large, which prolongs a time period required for equalization. In addition, depending on the usage of the battery pack, for example, under which electrical power of the battery pack is also used for various purposes, a time period during which electrical power of the battery pack is used is prolonged, which shortens the time period after the working polarization is canceled. Hence, also in these cases, when the equalization time period is limited to the time period after the polarization is canceled, the ability to perform equalization (current*time) of the equalization device may be lost.

The present disclosure has been made in light of such circumstances as stated above and mainly aims to increase the ability to perform equalization (current*time) of an equalization device.

Hereinafter, embodiments of the present disclosure will be described with reference to the drawings. It is noted that the present disclosure is not limited to the following embodiments and can be implemented with appropriate modifications within a scope not deviating from the gist of the present disclosure.

### First Embodiment

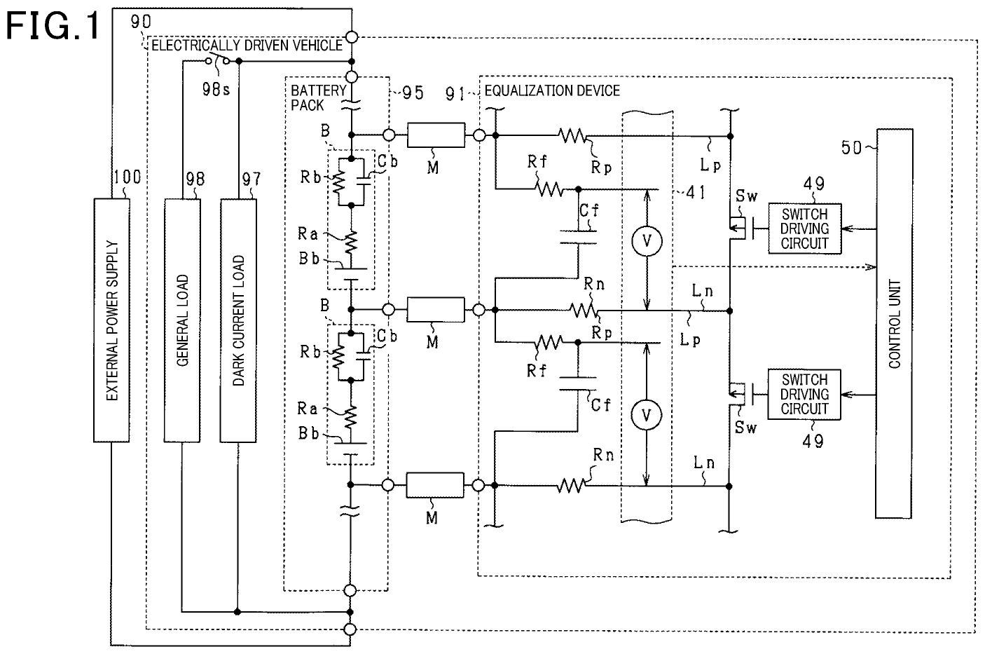

FIG. 1 is a circuit diagram illustrating an equalization device 91 and peripheral units thereof according to the first embodiment. Hereinafter, electrical connection will be simply referred to as connection. The equalization device 91 is installed in an electrically driven vehicle 90 such as an electric vehicle and a plug-in hybrid vehicle. In addition, the equalization device 91 is connected to a battery pack 95 installed in the electrically driven vehicle 90.

First, the battery pack 95 will be described. The battery pack 95 has a series connection body of cell batteries B such as lithium-ion batteries. Hereinafter, the voltage of the cell battery B having a highest voltage across terminals in the battery pack 95 is referred to as a maximum cell voltage Vmax, and the voltage of the cell battery B having a lowest voltage across terminals in the battery pack 95 is referred to as a minimum cell voltage Vmin. In addition, the voltage of the cell battery B at full charge time is referred to as a full charge cell voltage Vf. The difference obtained by subtracting the maximum cell voltage Vmax from the full charge cell voltage Vf is referred to as a margin voltage (Vf−Vmax). In addition, regarding each of the cell batteries B, the difference obtained by subtracting the minimum cell voltage Vmin from the voltage of the cell battery B is referred to as a variation voltage ΔV.

The battery pack 95 is connected to a general load 98 via a main power switch 98a such as an ignition switch and is connected to a dark current load 97 not via the main power switch 98s but via a step-down circuit (not shown) or the like. Hereinafter, the state in which the main power switch 98s is in an on state is referred to as a main power supply on state, and the state in which the main power switch 98s is in an off state is referred to as a main power supply off state. In addition, the time period during which the main power supply on state is maintained is referred to as a main power supply on time period, and the time period during which the main power supply off state is maintained is referred to as a main power supply off time period.

According to the above configuration, the battery pack 95 can supply power only to the dark current load 97 during the main power supply off state, and can supply power to both of the general load 98 and the dark current load 97 during the main power supply on state. It is noted that the dark current load 97 may be connected with, instead of or in addition to the battery pack 95, other supply power such as a low-voltage power supply.

Then, during charging time during which the battery pack 95 is charged, the battery pack 95 is connected with an external power supply 100. Hereinafter, the state in which the battery pack 95 is charged by the external power supply 100 is referred to as a charging state, and state in which the battery pack 95 is not charged is referred to as a non-charging state.

Each of the cell batteries B has a main part Bb that generates voltage in a state of an open circuit that does not configure a closed circuit, internal resistances Ra, Rb present in series with respect to the main part Bb, and a capacitive component Cb such as a parasitic capacitance present in parallel with one of the internal resistances Ra, Rb (Rb).

Next, problems to be solved by the present embodiment and an overview of a means of resolving the problems will be described. During charging time of the battery pack 95, a charging current flows in a charging direction in each of the cell batteries B, which increases voltage across terminals of the cell battery B by “internal resistances (Ra+Rb)*charging current”. At this time, in the capacitive component Cb, electric charge is stored until the voltage across terminals of the capacitive component Cb becomes equal to the voltage across terminals of the internal resistance Rb. Hereinafter, increase in the voltage across terminals in each of the cell batteries B due to the charging current is referred to as charging polarization. The charging polarization does not stabilize immediately even when charging the battery pack 95 is completed. This is because the electric charge in the capacitive component Cb flows from a high potential side of the capacitive component Cb to a low potential side through the internal resistance Rb, thereby decreasing gradually.

In contrast, in the main power supply on state or the like, a large amount of working current flows in a discharging direction in each of the cell batteries B, which decreases the voltage across terminals of the cell battery B by “internal resistances (Ra+Rb)*working current”. At this time, in the capacitive component Cb, electric charge is stored until the voltage across terminals of the capacitive component Cb becomes equal to the voltage across terminals of the internal resistance Rb. Hereinafter, the decrease in the voltage across terminals in each of the cell batteries B due to the working current is referred to as working polarization. The working polarization does not stabilize immediately even when using electrical power of the battery pack 95 is completed. This is because, as described above, the electric charge in the capacitive component Cb flows from the high potential side of the capacitive component Cb to the low potential side through the internal resistance Rb, thereby decreasing gradually.

Hereinafter, the charging polarization and the working polarization are collectively and simply referred to as polarization. From the above, typically, an equalization time period during which the variation voltage ΔV of each of the cell batteries B is decreased is limited to a time period after the polarization is canceled (after polarization cancelation). This is because the variation voltage ΔV cannot be correctly determined until the polarization stabilizes.

However, in the battery pack 95, since self-discharge typically increases as the capacity becomes higher, variation in the amount of charge also easily becomes large, which prolongs a time period required for equalization. In addition, depending on the usage of the battery pack 95, for example, under which electrical power of the battery pack 95 is also used for a purpose other than traveling the battery pack 95, a time period during which electrical power of the battery pack 95 is used is prolonged, which shortens the time period after the working polarization is canceled. Hence, also in these cases, when the equalization time period is limited to the time period after polarization cancelation, the ability to perform equalization (current*time) of the equalization device 91 may be lost.

Hence, not only after polarization cancelation but also during charging or while polarization is occurring (during occurrence of polarization), the equalization device 91 performs equalization discharge, which decreases the variation voltage ΔV of each of the cell batteries B, roughly compared with that after polarization cancelation, on condition that predetermined requirements are met. Furthermore, changing the start timing of the equalization discharge after polarization cancelation depending on the stated of the battery pack 95 makes the start timing as early as possible.

Next, a circuit configuration of the equalization device 91 will be described. The equalization device 91 has, for each of the cell batteries B, a positive electrode side line Lp, a negative electrode side line Ln, a lowpass filter (Rf, Cf), and a discharge switch Sw. It is noted that the negative electrode side line Ln of each of the cell batteries B is common to the positive electrode side line Lp of the adjacent cell battery B placed on the negative electrode side.

The positive electrode side line Lp is connected to a positive terminal of the cell battery B via a connection line M. The positive electrode side line Lp is connected with a positive electrode side resistor Rp, and the negative electrode side line Ln is connected with a negative electrode side resistor Rn.

The lowpass filter (Rf, Cf) is a series connection body of a filtering resistor Rf and a filtering capacitor Cf. The lowpass filter (Rf, Cf) connects a portion of the positive electrode side line Lp on the cell battery B side with respect to the positive electrode side resistor Rp and a portion of the negative electrode side line Ln on the cell battery B side with respect to the negative electrode side resistor Rn.

The discharge switch Sw is a semiconductor switch such as a MOSFET or an IGBT. A positive electrode side terminal (source terminal in FIG. 1) of the discharge switch Sw is connected to the side opposite to the cell battery B side with respect to the positive electrode side resistor Rp on the positive electrode side line Lp. In contrast, a negative electrode side terminal (drain terminal in FIG. 1) of the discharge switch Sw is connected to the side opposite to the cell battery B side with respect to the negative electrode side resistor Rn on the negative electrode side line Ln.

When each of the discharge switches Sw is turned on, a current flows from the positive electrode side line Lp corresponding to the discharge switch Sw to the negative electrode side line Ln, whereby the cell battery B corresponding to the discharge switch Sw discharges. Hereinafter, the current flowing when the discharge switch Sw is turned on is referred to as an equalization current, and the discharge of the cell battery B due to the equalization current is referred to as equalization discharge.

When the equalization discharge of each of the cell battery B is performed, in the cell battery B, an equalization current flows from the negative electrode side to the positive electrode side, whereby the voltage across terminals decreases by “internal resistances (Ra+Rb)*equalization current”. At this time, in the capacitive component Cb, electric charge is stored until the voltage across terminals of the capacitive component Cb becomes equal to the voltage across terminals of the internal resistance Rb. Hereinafter, the decrease in the voltage across terminals due to the equalization current is referred to as equalization polarization. The equalization polarization does not stabilize immediately even when the equalization discharge is completed. This is because, as described above, the electric charge in the capacitive component Cb flows from the high potential side of the capacitive component Cb to the low potential side through the internal resistance Rb, thereby decreasing gradually. Considering such equalization polarization, equalization discharge α1 at charging time is performed only during CC charge (constant current charge) and is not performed during CV charge (constant voltage charge). The details thereof will be described later.

Next, a control system of the equalization device 91 will be described. The equalization device 91 further has a measurement unit 41, a plurality of switch driving circuits 49, and a control unit 50. The measurement unit 41, the plurality of switch driving circuits 49, and the control unit 50 configure part of the dark current load 97. The measurement unit 41 has, for example, a multiplexer, and measures a voltage across terminals of a series connection body (Cf, Rn) of the filtering capacitor Cf and the negative electrode side resistor Rn as a voltage of the cell battery B corresponding to the series connection body.

The switch driving circuits 49 are provided to the discharge switches Sw, respectively. The switch driving circuits 49 are connected to control terminals (gate terminals in FIG. 1) of the discharge switches Sw corresponding to the respective switch driving circuits 49 and control on and off switching operations of the discharge switches Sw.

The control unit 50 is an electronic control unit (ECU) having a CPU, a RAM, a ROM, and the like. The control unit 50 transmits commands to the switch driving circuits 49 based on voltages of the respective cell batteries B measured by the measurement unit 41, thereby controlling the equalization discharge.

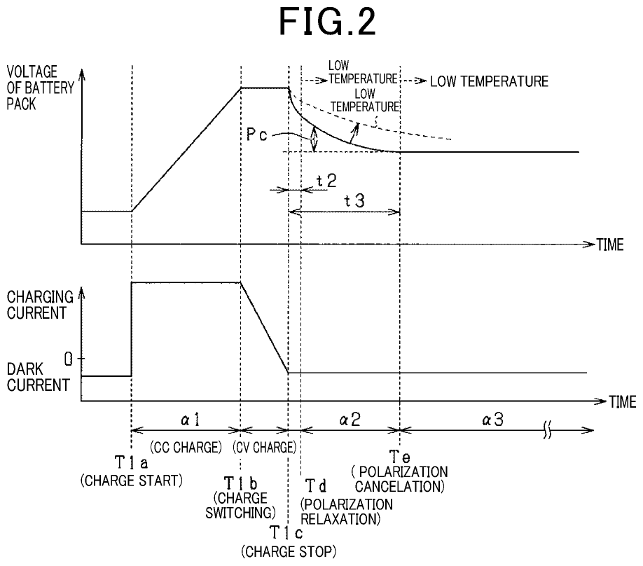

FIG. 2 is a graph illustrating changes of voltage and current of the battery pack 95 during a charging period and after charging. First, the charging period (T1a to T1c) of the battery pack 95 will be described. The external power supply 100 performs CC charge while the margin voltage (Vf−Vmax) is high and switches to CV charge when the margin voltage (Vf−Vmax) becomes low. Hence, the external power supply 100 performs the CC charge from a charge start timing T1a to a charge switching timing T1b before a charge end timing T1c, and performs the CV charge from the charge switching timing T1b to the charge end timing T1c.

Hence, from the charge start timing T1a to the charge switching timing T1b, the charging current is constant, and the voltage applied between the terminals of the battery pack 95 gradually increases. In contrast, from the charge switching timing T1b to the charge end timing T1c, the voltage applied between the terminals of the battery pack 95 is constant, and the charging current gradually decreases.

Next, the reason why the equalization discharge α1 at charging time is performed only during CC charge (T1a to T1b) and is not performed during CV charge (T1b to Y1c), described above, will be described. During CC charge, charging is controlled based on current. In contrast, during CV charge, charging is controlled based on voltage. Hence, compared with a case during CC charge, during CV charge, high accuracy and a high frequency are required for measuring a voltage. Regardless of this, if equalization polarization occurs, at least one of the accuracy and frequency in measuring a voltage of the battery pack 95 is required to be decreased.

That is, in order to prevent the accuracy in measuring the voltage of battery pack 95 from decreasing, relaxation time for equalization polarization, that is, the time period from the end of the equalization discharge to the voltage measurement is required to be ensured so as to be sufficiently long. Hence, the frequency in measuring the voltage is required to decrease. Thus, the sufficient frequency in measuring the voltage cannot be ensured for performing CV charge. In contrast, when the frequency in measuring the voltage is not decreased, relaxation time for equalization polarization cannot be sufficiently ensured. Hence, the accuracy in measuring the voltage decreases. Thus, the sufficient accuracy in measuring the voltage cannot be ensured for performing CV charge.

Hence, as described above, during charging (T1a to T1c), the control unit 50 performs the equalization discharge α1 only during CC charge (T1a to T1b). When the equalization discharge α1 is performed, at least one of the accuracy and frequency in measuring voltage is decreased compared with a case in which the equalization discharge α1 is not performed during CC charge and a case during CV charge, and the voltage of the battery pack 95 is measured. However, it can be accepted because, in CC charge, the accuracy and frequency in measuring voltage is not important compared with a case of CV charge.

Next, the battery pack 95 after charging (from T1c) will be described. Hereinafter, elapsed time t from the charge end timing T1c of the battery pack 95 is referred to as elapsed time t after charging. While the elapsed time t after charging is short, the charging polarization does not sufficiently stabilize. Hence, the voltage of each of the cell batteries B becomes higher than the voltage, which is depending on the amount of charge of the cell battery B, by the amount corresponding to the charging polarization. Hence, the voltage of the battery pack 95 becomes higher than the voltage, which is depending on the amount of charge of the cell battery B, by a charging polarization integrated value Pc obtained by summing charging polarization in each of the cell batteries B.

Hence, during such a time period before the charging polarization is canceled, the equalization device 91 performs equalization discharge α2 during occurrence of polarization relatively roughly. Specifically, the equalization discharge α2 during occurrence of polarization is performed during a time period (Td to Te) from a relaxation timing Td at which the charging polarization is relaxed to some extent to a cancellation timing Te at which the charging polarization can be assumed to be canceled. Then, after the cancellation timing Te, equalization discharge α3 after polarization cancelation is performed with relatively high accuracy.

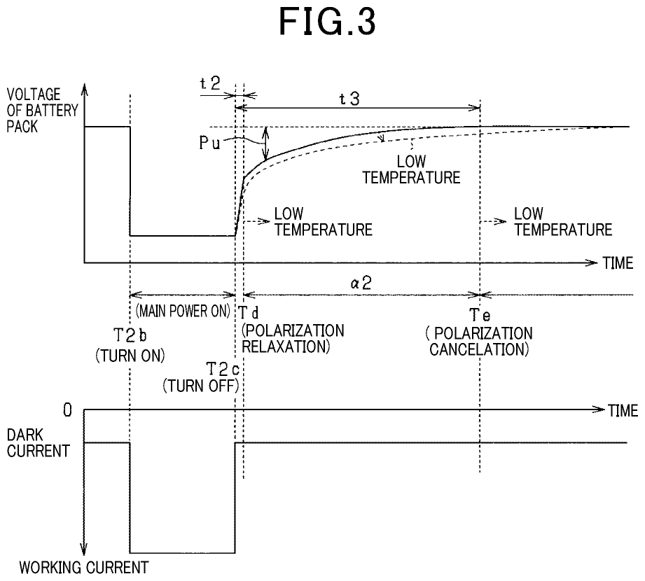

As indicated by a broken line in FIG. 3, as the temperature of the battery pack 95 decreases, the relaxation rate of the charging polarization decreases. In contrast, as the temperature of the battery pack 95 increases, the relaxation rate increases. Hence, as indicated by arrows with a broken line in FIG. 3, as the temperature of the battery pack 95 decreases, the relaxation timing Td and the cancellation timing Te of the charging polarization are delayed. In contrast, as the temperature of the battery pack 95 increases, the relaxation timing Td and the cancellation timing Te of the charging polarization becomes earlier.

FIG. 3 is a graph illustrating changes of voltage and current during a main power supply on time period and after the period. The electrically driven vehicle 90 uses a large amount of electrical power of the battery pack 95 during the main power supply on time period (T2b to T2c). Hence, during the main power supply on time period (T2b to T2c), the working current becomes high compared with a case during the main power supply off time period (to T2b, from T2c).

Hereinafter, the time after the end of the main power supply on time period (T2b to T2c) is referred to as “after main power supply off”, and the elapsed time from the end of the main power supply on time period (T2b to T2c) is referred to as “elapsed time t after main power supply off”. While the elapsed time t after main power supply off is short, the working polarization does not sufficiently stabilize. Hence, the voltage of each of the cell batteries B becomes lower than the voltage, which is depending on the amount of charge of the cell battery B, by the amount corresponding to the working polarization. Hence, the voltage of the battery pack 95 becomes lower than the voltage, which is depending on the amount of charge of the cell battery B, by the amount corresponding a working polarization integrated value Pu obtained by summing working polarization in each of the cell batteries B.

Hence, as in the case after charging described above, during such a time period before the working polarization is canceled, the equalization device 91 performs the equalization discharge α2 during occurrence of polarization relatively roughly. Specifically, the equalization discharge α2 during occurrence of polarization is performed during a time period (Td to Te) from the relaxation timing Td at which the working polarization is relaxed to some extent to the cancellation timing Te at which the working polarization can be assumed to be canceled. Then, after the cancellation timing Te, the equalization discharge α3 after polarization cancelation is performed with relatively high accuracy.

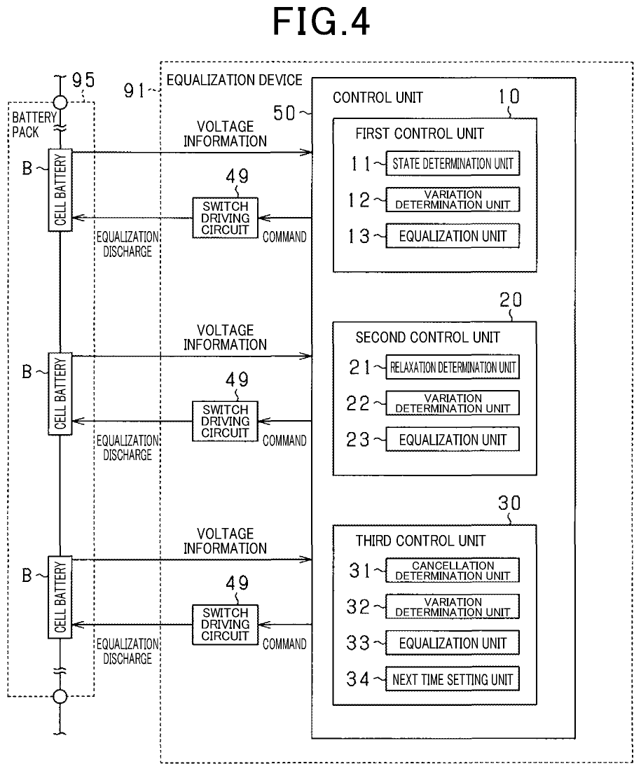

FIG. 4 is a block diagram illustrating the control unit 91 and peripheral units thereof. The control unit 50 has a first control unit 10 that controls the equalization discharge α1 at charging time, a second control unit 20 that controls the equalization discharge α2 during occurrence of polarization, and a third control unit 30 that controls the equalization discharge α3 after polarization cancelation.

First, the first control unit 10 will be described. The first control unit 10 has a state determination unit 11, a variation determination unit 12, and an equalization unit 13. It is noted that the variation determination unit 12 herein differs from other variation determination units 22, 23 described later in that the variation determination unit 12 is a charging time variation determination unit that makes a variation determination during charging. In addition, the equalization unit 13 herein differs from other equalization units 23, 33 described later in that the equalization unit 13 is a charging time equalization unit that performs the equalization discharge α1 at charging time.

During the charging period of battery pack 95, the state determination unit 11 determines whether the margin voltage (Vf−Vmax) is higher than a predetermined threshold margin voltage Vth (Vf−Vmax>Vth). Then, if determining that the margin voltage (Vf−Vmax) is higher than the threshold margin voltage Vth (Vf−Vmax>Vth), the state determination unit 11 determines it to be during CC charge.

The variation determination unit 12 determines, for each of the cell batteries B, whether the variation voltage ΔV is higher than a determination voltage V1 at charging time. The determination voltage V1 at charging time is a voltage serving as a threshold value for determining whether the equalization discharge α1 is performed during CC charge. As the determination voltage V1 at charging time, a value is set which is larger than an assumed error of the variation voltage ΔV due to the equalization polarization. Hence, when the accuracy in measuring the voltage of the battery pack 95 is not decreased, and the frequency in measuring the voltage is decreased, the determination voltage V1 at charging time is not required to be set to be high. In contrast, when the frequency in measuring the voltage is not decreased, and the accuracy in measuring the voltage is decreased, the determination voltage V1 at charging time is required to be set to be higher by the amount corresponding to the decreased accuracy. It is noted that the error of the variation voltage ΔV due to the equalization polarization may be, for example, previously measured by experiment or calculated by simulation analysis or the like.

If the state determination unit 11 determines it to be during CC charge, and the variation determination unit 12 determines, regarding any of the cell batteries B, that the variation voltage ΔV is higher than the determination voltage V1 at charging time, the equalization unit 13 performs the equalization discharge α1 at charging time for the cell battery B.

Next, the second control unit 20 will be described. The second control unit 20 has a relaxation determination unit 21, a variation determination unit 12, and an equalization unit 23. It is noted that the variation determination unit 22 herein differs from other variation determination units 12, 32 in that the variation determination unit 22 is a polarization time variation determination unit that makes a variation determination during occurrence of polarization. In addition, the equalization unit 23 herein differs from other equalization units 13, 33 in that the equalization unit 23 is a polarization time equalization unit that makes a variation determination during occurrence of polarization. Hereinafter, the elapsed time t after charging and the elapsed time t after main power supply off are collectively and simply referred to as an elapsed time t.

After charging and after main power supply off, the relaxation determination unit 21 determines whether the elapsed time t is longer than a relaxation determination time period t2. The relaxation determination time period t2 is a time period serving as a threshold value for determining whether the charging polarization and the working polarization of the cell battery B are relaxed equal to or more than a predetermined criterion. The relaxation determination unit 21 sets the relaxation determination time period t2 based on a state of the cell battery B at the charge end timing T1c of the battery pack 95 or a turn off timing T2c of the main power switch 98s. The details thereof will be described below.

Hereinafter, a case in which a temperature is higher than a predetermined temperature with respect to a case in which a temperature is lower than the predetermined temperature is simply referred to as a higher case. A case in which a value is larger than a predetermined value with respect to a case in which a value is smaller than the predetermined value is simply referred to as a larger case. A case in which a value is smaller than a predetermined value with respect to a case in which a value is larger than the predetermined value is simply referred to as a smaller case.

First, the relaxation determination unit 21 sets the relaxation determination time period t2 based on the temperature of the cell battery B. Specifically, since the polarization is relaxed faster as the temperature of the battery pack 95 is higher, the relaxation determination unit 21 sets the relaxation determination time period t2 to be short. In addition, the relaxation determination unit 21 sets the relaxation determination time period t2 based on SOHpw (State Of Health power). The SOHpw is a variable indicating that the internal resistances Ra, Rb are lower as the value thereof is larger. Hence, as the SOHpw of the battery pack 95 is larger, the internal resistances Ra, Rb are lower, whereby the polarization is relaxed faster. Hence, the relaxation determination unit 21 sets the relaxation determination time period t2 to be short.

In addition, the relaxation determination unit 21 changes the relaxation determination time period t2 based on SOC (State Of Charge) indicating a charging state of the battery pack 95. Specifically, for example, in the present embodiment, after charging, when SOC of the battery pack 95 at the charge end timing T1c is small, that is, as the amount of charge is smaller, the charging polarization can be reduced more easily. Hence, the relaxation determination unit 21 sets the relaxation determination time period t2 to be short. In contrast, after main power supply off, when SOC of the battery pack 95 at the turn off timing T2c is large, that is, as power consumption is lower, the working polarization can be reduced more easily. Hence, the relaxation determination unit 21 sets the relaxation determination time period t2 to be short.

The variation determination unit 22 determines whether the variation voltage ΔV is higher than a determination voltage V2 during occurrence of polarization. The determination voltage V2 during occurrence of polarization is a voltage serving as a threshold value for determining whether the equalization discharge α2 is performed during occurrence of polarization. The determination voltage V2 during occurrence of polarization is set assuming a next error. That is, the equalization discharge α2 during occurrence of polarization is performed before the polarization in each of the cell batteries B is cancelled. Hence, an error due to the polarization is included in a measurement value of the voltage of each of the cell batteries B. Hence, so as to be able to absorb the error due to the polarization, the variation determination unit 22 sets a voltage value at least larger than the error due to the polarization as the determination voltage V2 during occurrence of polarization. It is noted that the error due to the polarization may be, for example, previously measured by experiment or calculated by simulation analysis or the like.

As in the relaxation determination time period t2, the determination voltage V2 during occurrence of polarization is also set based on the state of the cell battery B at the charge end timing T1c of the battery pack 95 or the turn off timing T2c of the main power switch 98s.

Specifically, since the polarization is relaxed faster as the temperature of the battery pack 95 is higher, the variation determination unit 22 sets the determination voltage V2 during occurrence of polarization to be low. In addition, as the SOHpw of the battery pack 95 is larger, the internal resistances Ra, Rb are lower, whereby the polarization is relaxed faster. Hence, the variation determination unit 22 sets the determination voltage V2 during occurrence of polarization to be low.

In addition, the variation determination unit 22 changes the determination voltage V2 based on the SOC of the battery pack 95. Specifically, for example, in the present embodiment, after charging, when the SOC of the battery pack 95 at the charge end timing T1c is small, that is, as the amount of charge is smaller, the charging polarization can be reduced more easily. Hence, the variation determination unit 22 sets the determination voltage V2 during occurrence of polarization to be low. In contrast, after main power supply off, when the SOC of the battery pack 95 at the turn off timing T2c is large, that is, as power consumption is lower, the working polarization can be reduced more easily. Hence, the determination voltage V2 during occurrence of polarization is set to be low.

When the determination unit 21 determines that the elapsed time t is longer than the relaxation determination time period t2, if the variation determination unit 22 determines that the variation voltage ΔV of any of the cell batteries B is higher than the determination voltage V2 during occurrence of polarization, the equalization unit 23 performs, for the corresponding cell battery B, the equalization discharge α2 during occurrence of polarization.

Next, the third control unit 30 will be described. The third control unit 30 has a relaxation determination unit 31, a variation determination unit 32, an equalization unit 33, and a next time setting unit 34. It is noted that the variation determination unit 32 herein differs from other variation determination units 12, 22 in that the variation determination unit 32 is a post-cancellation variation determination unit that makes a variation determination after the polarization is canceled. In addition, the equalization unit 33 herein differs from other equalization units 13, 23 in that the equalization unit 33 is a post-cancellation equalization unit that performs the equalization discharge α3 after the polarization is canceled.

After charging and after main power supply off, the relaxation determination unit 31 determines whether the elapsed time t is longer than a cancellation determination time period t3, which is longer than the relaxation determination time period t2 described above. The cancellation determination time period t3 is a time period serving as a threshold value for determining whether the polarization of the cell battery B has been canceled. As in the relaxation determination time period t2, the cancellation determination time period t3 is set based on the state of the cell battery B at the charge end timing T1c or the turn off timing T2c.

That is, since the polarization is canceled faster as the temperature of the battery pack 95 is higher, the relaxation determination unit 31 sets the cancellation determination time period t3 to be short. In addition, as the SOHpw of the battery pack 95 is larger, the internal resistances Ra, Rb are lower, whereby the polarization is relaxed faster. Hence, the relaxation determination unit 31 sets the cancellation determination time period t3 to be short.

In addition, the relaxation determination unit 31 changes the cancellation determination time period t3 based on the SOC of the battery pack 95. Specifically, for example, in the present embodiment, after charging of the battery pack 95, when the SOC of the battery pack 95 at the charge end timing T1c is small, that is, as the amount of charge is smaller, the charging polarization can be reduced more easily. Hence, the relaxation determination unit 31 sets the cancellation determination time period t3 to be low. In contrast, after main power supply off, when the SOC of the battery pack 95 at the turn off timing T2c is large, that is, as power consumption is lower, the working polarization can be reduced more easily. Hence, the relaxation determination unit 31 sets the cancellation determination time period t3 to be short.

The variation determination unit 32 determines, for each of the cell batteries B, whether the variation voltage ΔV is higher than a determination voltage V3 after polarization cancelation. The determination voltage V3 after polarization cancelation is a voltage serving as a threshold value for determining whether the equalization discharge α3 is performed after polarization cancelation. The determination voltage V3 after polarization cancelation is lower than the determination voltage V1 at charging time and the determination voltage V2 during occurrence of polarization. Hence, the equalization discharge α3 after polarization cancelation is performed with high accuracy compared with the equalization discharge α1 at charging time and the equalization discharge α2 during occurrence of polarization.

Unlike the case in which the equalization discharge α2 during occurrence of polarization is performed, when the equalization discharge α3 after polarization cancelation is performed, the polarization does not affect voltage measurement values of each of the cell batteries B. Hence, to absorb at least a measurement error of a voltage of the cell battery B produced in the measurement unit 41, it is sufficient for the variation determination unit 32 to set a voltage value at least larger than the measurement error as the determination voltage V3 after polarization cancelation.

When the relaxation determination unit 31 determines that the elapsed time t is longer than the cancellation determination time period t3, if the variation determination unit 32 determines that the variation voltage ΔV of any of the cell batteries B is higher than the determination voltage V3 after polarization cancelation, the equalization unit 33 performs, for the corresponding cell battery B, the equalization discharge α3 after polarization cancelation.

Next, the next time setting unit 34 of the third control unit 30 will be described. Hereinafter, the timing at which it is determined whether the equalization discharge α3 after polarization cancelation is performed by the relaxation determination unit 31, the variation determination unit 32, and equalization unit 33 is referred to as a determination timing. The next time setting unit 34 sets a time period until the next determination timing based on the state of the cell battery B.

Specifically, first, the next time setting unit 34 sets a time period until a next determination timing based on the variation voltage ΔV of the cell battery B at a current determination timing. That is, since the time period required for the equalization discharge α3 becomes longer as the variation voltage ΔV of the cell battery B, whose variation voltage ΔV is minimum among those of the cell batteries B performing the equalization discharge α3, is higher, the next time setting unit 34 sets the time period until the next determination timing to be long. Hence, specifically, the time period required for equalization of the cell battery B, whose variation voltage ΔV is minimum among those of the cell batteries B performing the equalization discharge α3, is set as the time period until the next determination timing.

In addition, the next time setting unit 34 sets the time period until the next determination timing based on the amplitude of an equalization current of the cell battery B at the current determination timing. That is, the next time setting unit 34 measures the amplitude of the equalization current. As the equalization current is lower, the time period required for the equalization discharge α3 becomes longer. Hence, the next time setting unit 34 sets the time period until the next determination timing to be long.

It is noted that the equalization current may be measured by using an ammeter or by calculation. Specifically, for example, the equalization current can be calculated by dividing the voltage of the cell battery B by the magnitude of a resistance of the whole discharge path in the equalization discharge α3 of the cell battery B. In addition, for example, instead of the above calculation method, a voltage across terminals of a predetermined resistor (e.g., the positive electrode side resistor Rp) through which the equalization current flows may be divided by the magnitude of the resistance to calculate the equalization current.

Next, a startup state of the control unit 50 will be described. In an on state, which is not a sleep state, the control unit 50 controls the equalization discharge α1 at charging time and the equalization discharge α2 during occurrence of polarization. Then, after the polarization is canceled, the control unit 50 becomes a sleep state or an off state once. Then, at the determination timing, the control unit 50 wakes from the sleep state or the off state, and the relaxation determination unit 31, the variation determination unit 32, and the equalization unit 33 of the third control unit 30 in the control unit 50 control the equalization discharge α3. Then, the next time setting unit 34 in the third control unit 30 sets a time period until the next determination timing. Thereafter, until the next determination timing, the control unit 50 is in a sleep state or an off state again. By repeating the above, the equalization discharge α3 after polarization cancelation is controlled while power is saved as much as possible.

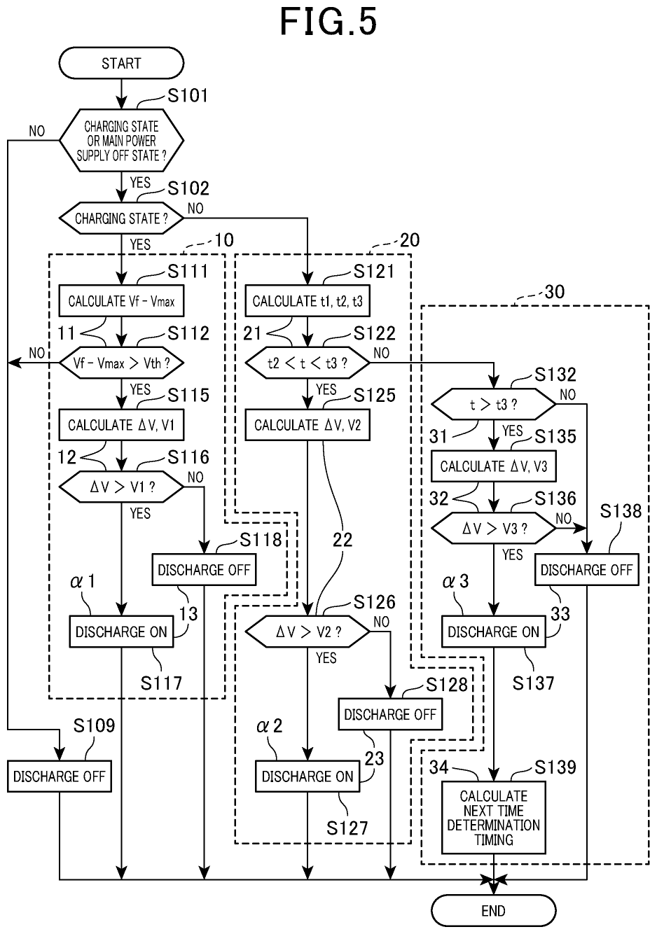

FIG. 5 is a flowchart illustrating control of the equalization discharge α1 to α3 performed by the control unit 50. First, in S101, the control unit 50 determines whether it is in a charging state or a main power supply off state (whether there is a charging state or a main power supply off state). If the requirement in S101 is not met, that is, if it is in a non-charging state and a main power supply on state (S101: NO), the control unit 50 proceeds to S109 to turn off the discharge switches Sw, and then ends the flow. In contrast, in S101, if determining that it is in a charging state or a main power supply off state (S101: YES), in succeeding S102, the control unit 50 determines whether it is in a charging state (whether a charging state is present). If determining that it is in a charging state (S102: YES), the control unit 50 proceeds to S111 to determine whether to perform the equalization discharge α1 at charging time.

In S111, the control unit 50 detects a margin voltage (Vf−Vmax). Then, in succeeding S112, the control unit 50 determines whether the margin voltage (Vf−Vmax) is higher than the predetermined threshold margin voltage Vth. If determining to be not higher than the threshold margin voltage Vth (S112: NO), the control unit 50 assumes that it is during CV charge and proceeds to S109 to turn off the discharge switches Sw, and then ends the flow. In contrast, in S112, if determining that the margin voltage (Vf−Vmax) is higher than the threshold margin voltage Vth (S112: YES), the control unit 50 assumes that it is during CC charge and proceeds to S115 to determine whether to continuously perform the equalization discharge α1 at charging time.

In S115, the control unit 50 detects the variation voltage ΔV regarding each of the cell batteries B and calculates the determination voltage V1 at charging time. In succeeding S116, regarding each of the cell batteries B, the control unit 50 determines whether the variation voltage ΔV is higher than the determination voltage V1 at charging time. If determining to be higher than the determination voltage V1 at charging time (S116: YES), the control unit 50 turns on the discharge switch Sw corresponding to the cell battery B and ends the flow. In contrast, in S116, if determining that the variation voltage ΔV is not higher than the determination voltage V1 at charging time (S116: NO), the control unit 50 turns off the discharge switch Sw corresponding to the cell battery B and ends the flow.

In contrast, in previous step S102, if it is determined that it is not in a charging state (S102: NO), it means that it is in a non-charging state and that it is in a main power supply off state based on previous step S101. Hence, the control unit 50 proceeds to S121 to determine whether to perform the equalization discharge α2 during occurrence of polarization or the equalization discharge α3 after polarization cancelation.

In step S121, the control unit 50 calculates the elapsed time t, the relaxation determination time period t2, and the cancellation determination time period t3. In succeeding S122, the control unit 50 determines whether the elapsed time t is longer than the relaxation determination time period t2 and shorter than the cancellation determination time period t3. If determining that the requirement is met (S122: YES), the control unit 50 proceeds to S125 to determine whether to perform the equalization discharge α2 during occurrence of polarization.

In S125, the control unit 50 calculates the variation voltage ΔV regarding each of the cell batteries B and calculates the determination voltage V2 during occurrence of polarization. In succeeding S126, regarding each of the cell batteries B, the control unit 50 determines whether the variation voltage ΔV is higher than the determination voltage V2 during occurrence of polarization. If determining to be higher than the determination voltage V2 during occurrence of polarization (S126: YES), the control unit 50 turns on the discharge switch Sw corresponding to the cell battery B and ends the flow. In contrast, in S126, if determining that the variation voltage ΔV is not higher than the determination voltage V2 during occurrence of polarization (S116: NO), the control unit 50 turns off the discharge switch Sw corresponding to the cell battery B and ends the flow.

In contrast, in previous step S122, if it is determined to not be meet the requirement (t2<t<t3) (S122: NO), it means that the elapsed time t is not longer than the relaxation determination time period t2 or not shorter than the cancellation determination time period t3. Hence, the control unit 50 proceeds to S132 to determine whether to perform the equalization discharge α3 after polarization cancelation.

In S132, the control unit 50 determines whether the elapsed time t is longer than the cancellation determination time period t3. If it is determined the elapsed time t is not longer than the cancellation determination time period t3 (S132: NO), it means that the elapsed time t is not longer than the relaxation determination time period t2 based on previous step S122. Hence, the control unit 50 proceeds to S138 to turn off each of the discharge switches Sw, and then ends the flow. In contrast, in S132, if determining that the elapsed time t is longer than the cancellation determination time period t3 (S132: YES), the control unit 50 proceeds to S135 to determine whether to continuously perform the equalization discharge α3 after polarization cancelation.

In S135, the control unit 50 calculates the variation voltage ΔV regarding each of the cell batteries B and calculates the equalization discharge α3 after polarization cancelation. In succeeding S136, regarding each of the cell batteries B, the control unit 50 determines whether the variation voltage ΔV is higher than the determination voltage V3 after polarization cancelation. If determining to be higher than the determination voltage V3 after polarization cancelation (S136: YES), the control unit 50 proceeds to S137 to turn on the discharge switch Sw corresponding to the cell battery B, and then proceeds to S139. In contrast, in S136, if determining that the variation voltage ΔV is not higher than the determination voltage V3 after polarization cancelation, (S136: NO), the control unit 50 proceeds to S138 to turn off the discharge switch Sw corresponding to the cell battery B, and then ends the flow.

In S139, based on the state of the battery pack 95, that is, the temperature, the SOHpw, and the SOC of the battery pack 95, the next time setting unit 34 sets a time period until the next determination timing and ends the flow. Then, at the next determination timing, the control unit 50 restarts the flow from the beginning. It is noted that when S139 is not passed through, and the next determination timing is not set, the control unit 50 restarts the flow from the beginning after a predetermined time period.

According to the present embodiment, the following effects are obtained. The equalization device 91 performs the equalization discharge α1 not only after charging of the battery pack 95 (from T1c) but also during charging (T1a to T1c). Hence, the time period during which the equalization can be performed can be prolonged by the added period, thereby increasing the ability to perform equalization (current*time).

Furthermore, the equalization is performed if it is determined to be during CC charge. During CC charge, since charging is controlled based of a current, high accuracy and a high frequency are not required for measuring voltage compared with a case during CV charging during which charging is controlled based on voltage. Hence, during CC charge, even if the accuracy and frequency in measuring voltage are decreased due to the equalization, problems are not caused compared with the case during CV charging.

Hence, according to the embodiment, while adverse effects due to the decrease in accuracy and a frequency for measuring voltage due to the equalization is suppressed, the time period during which the equalization can be performed can be prolonged, thereby increasing the ability to perform equalization (current*time).

In addition, if determining that the margin voltage (Vf−Vmax) is higher than the threshold margin voltage Vth while the battery pack 95 is charged, the state determination unit 11 determines that the battery pack 95 is in CC charging. Hence, based on the margin voltage (Vf−Vmax), it can be efficiently determined whether the battery pack 95 is in CC charging.

In addition, the variation determination unit 12 sets a voltage value at least higher than a voltage error of the cell battery B produced due to the equalization discharge α1 as determination voltage V1 at charging time. Hence, there is no risk that due to the voltage error, voltage of the cell battery B not subjected to equalization discharge α1 will be wastefully discharged.

In addition, when it is determined that the elapsed time t is longer than the relaxation determination time period t2, if it is determined that the variation voltage ΔV is higher than the determination voltage V2 during occurrence of polarization higher than the determination voltage V3 at polarization cancelation time, the equalization unit 23 of the second control unit 20 performs the equalization discharge α2 during occurrence of polarization. Hence, even during occurrence of polarization, if the variation voltage ΔV is higher than the determination voltage V2 during occurrence of polarization higher than the determination voltage V3 at polarization cancelation time, the equalization can be performed. Hence, also in this point, the time period during which the equalization can be performed can be prolonged, thereby increasing the ability to perform equalization (current*time).

In addition, the relaxation determination unit 31 of the third control unit 30 sets the cancellation determination time period t3 based on the state of the battery pack 95. Hence, the cancellation determination time period t3 can be exactly set easily, whereby the cancellation determination time period t3 can be avoided from being set to be unnecessary long. Hence, it is easy to shift, as early as possible, to the equalization discharge α3 after polarization cancelation performed with relatively high accuracy. Hence, also in this point, the ability to perform equalization (current*time) can be increased.

In addition, as the variation voltage ΔV at the current determination timing is higher, the next time setting unit 34 sets the time period until the next determination timing to be longer. Hence, in a state in which the variation voltage ΔV is high and a long time period is required for the equalization discharge α3, the time period until the next determination timing can be set to be long. Hence, the number of determinations can be decreased as much as possible, thereby suppressing dark current.

In addition, as the equalization current is lower, the next time setting unit 34 sets the time period until the next determination timing to be longer. Hence, in a state in which the equalization current is lowered and a long time period is required for the equalization discharge α3, the time period until the next determination timing can be set to be long. Hence, also in this point, the number of determinations can be decreased as much as possible, thereby suppressing dark current.

As described above, the next time setting unit 34 sets the time period until the next determination timing based on the time period required for the equalization discharge α3. Hence, unlike the case in which the time period until the determination timing is simply set to be long, there is no risk that maintaining the on state of the discharge switch Sw until the next determination timing causes an overshoot of the equalization discharge α3.

### Second Embodiment

Next, a second embodiment will be described. It is noted that, in the following embodiments, the same reference sign is appended to a component or the like identical or corresponding to that in the previous embodiment. It is noted that different reference signs are appended to equalization devices of the respective embodiments. In the present embodiment, parts different from those of the first embodiment will be mainly described, and descriptions of parts identical or similar to those of the first embodiment are appropriately omitted.

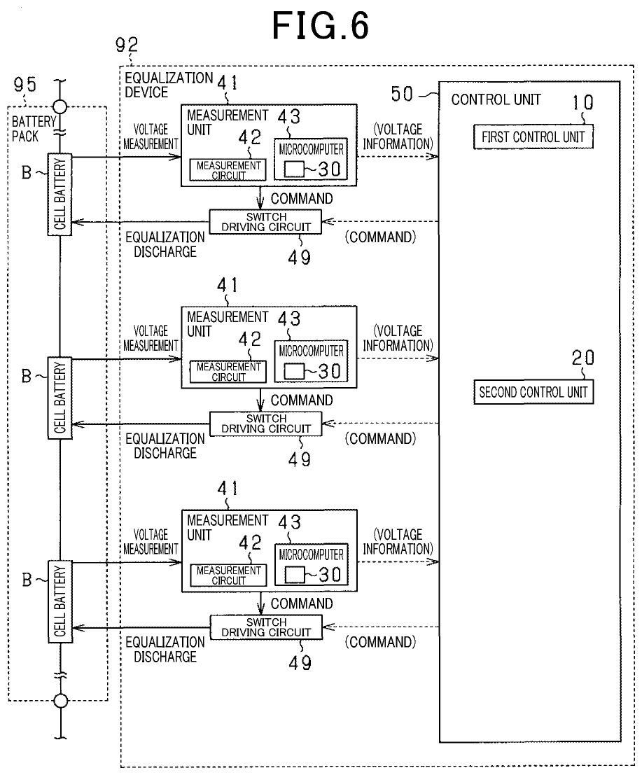

FIG. 6 is a block diagram illustrating an equalization device 92 and peripheral units thereof according to the present embodiment. The equalization device 92 has a plurality of measurement units 41 for the respective cell batteries B instead of the measurement unit 41 having a multiplexer and the like according to the first embodiment. Each of the measurement units 41 has a measurement circuit 42 that measures a voltage of the cell battery B corresponding thereto and a microcomputer 43 that controls the measurement circuit 42. The control unit 50 collects voltages measured by the measurement units 41.

The first control unit 10 and the second control unit 20 are provided in the control unit 50 as in the first embodiment. In contrast, a plurality of third control units 30 are provided in the respective microcomputers 43 of the measurement units 41.

The equalization discharge α1 at charging time and the equalization discharge α2 during occurrence of polarization are controlled by the first control unit 10 and the second control unit 20 in the control unit 50 in an on state in which neither of the microcomputer 43 and the control unit 50 are in sleep states. Then, after the polarization is canceled, both of the control unit 50 and the microcomputer 43 once become sleep states or off states.

Then, at the determination timing, in a state in which the control unit 50 is in the sleep state or the off state, the microcomputer 43 wakes, and the third control unit 30 in the microcomputer 43 controls the equalization discharge α3. Then, the next time setting unit 34 in the third control unit 30 sets a time period until the next determination timing. The time periods until the next determination timing differ between the microcomputers 43. Thereafter, until the next determination timing, the microcomputer 43 is in a sleep state or an off state again. By repeating the above, the equalization discharge α3 after polarization cancelation is controlled while power is saved as much as possible.

As described above, according to the present embodiment, after the polarization is canceled, in a state in which the control unit 50 is in a sleep state or an off state, the microcomputer 43 controls the equalization discharge α3 and can set a time period until the next determination timing. Hence, dark current can be further suppressed compared with the state of the first embodiment.

In addition, the microcomputers 43 provided for the respective cell batteries B set different determination timings for the respective microcomputers 43 and wake at different timings. Hence, the number of wake-up of each of the microcomputer 43 can be decreased as much as possible. Hence, also in this point, dark current can be suppressed.

### Third Embodiment

Next, a third embodiment will be described. In the present embodiment, parts different from those of the second embodiment will be mainly described, and descriptions of parts identical or similar to those of the second embodiment are appropriately omitted.

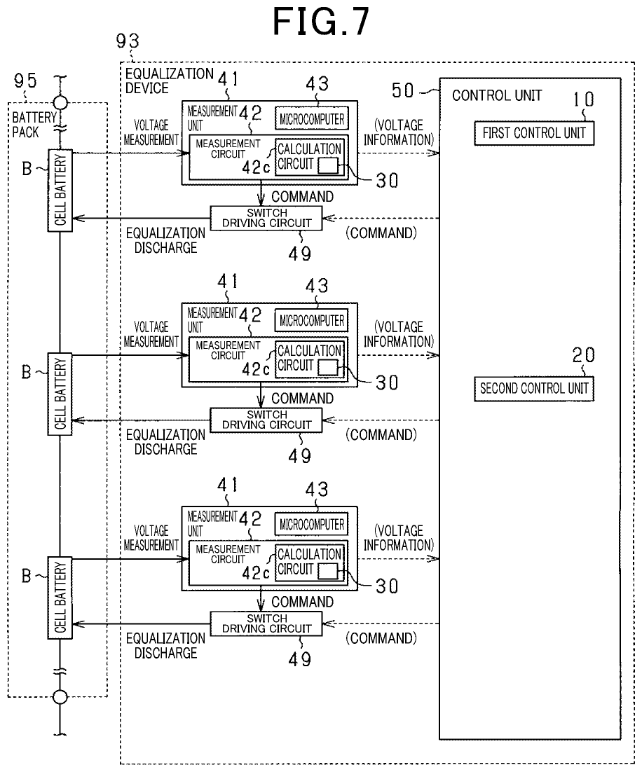

FIG. 7 is a block diagram illustrating an equalization device 93 and peripheral units thereof according to the present embodiment. Each of the measurement circuits 42 has, in addition to the microcomputer 43, a calculation circuit 42c. In the calculation circuit 42c, the third control unit 30 is provided.

The equalization discharge α1 at charging time and the equalization discharge α2 during occurrence of polarization are controlled by the first control unit 10 and the second control unit 20 in the control unit 50 in an on state in which none of the calculation circuit 42c, the microcomputer 43, and the control unit 50 are in sleep states. Then, after the polarization is canceled, the control unit 50, the microcomputer 43, and the calculation circuit 42c once become sleep states or off states.

Then, at the determination timing after polarization cancelation, in a state in which the control unit 50 and the microcomputer 43 are in the sleep states or the off states, the calculation circuit 42c wakes, and the third control unit 30 in the calculation circuit 42c controls the equalization discharge α3. Then, the next time setting unit 34 in the third control unit 30 sets a time period until the next determination timing. Thereafter, until the next determination timing, the calculation circuit 42c is a sleep state or an off state again. By repeating the above, the equalization discharge α3 after polarization cancelation is controlled while power is saved as much as possible.

As described above, according to the present embodiment, in a state in which not only the control unit 50 but also the microcomputer 43 are in sleep states, the calculation circuit 42c controls the equalization discharge α3 and can set a time period until the next determination timing. Hence, dark current can be further suppressed compared with the second embodiment.

### Fourth Embodiment

Next, a fourth embodiment will be described. In the present embodiment, parts different from those of the third embodiment will be mainly described, and descriptions of parts identical or similar to those of the third embodiment are appropriately omitted.

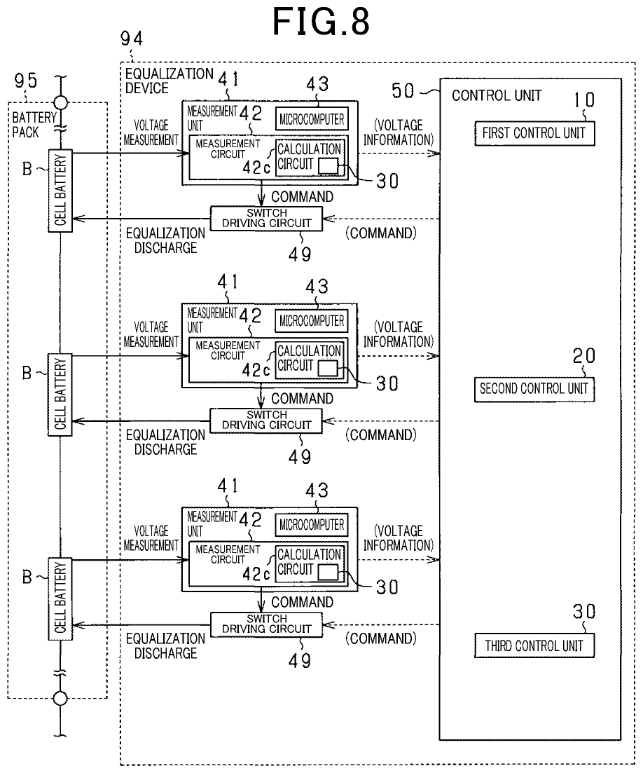

FIG. 8 is a block diagram illustrating an equalization device 94 and peripheral units thereof according to the present embodiment. The control unit 50 has the third control unit 30. That is, the third control units 30 are included in the control unit 50 and the calculation circuits 42c. After the polarization is canceled, until the equalization discharge α3 is controlled after first polarization cancelation, the control unit 50, the microcomputer 43, and the calculation circuits 42c maintain on states, which are not sleep states. Then, the equalization discharge α3 after first polarization cancelation is controlled by the third control unit 30 in the control unit 50. Then, the next time setting unit 34 in the control unit 50 calculates time periods until the respective next determination timings for the respective cell batteries B and transmits the time periods to the respective third control units 30 in the corresponding calculation circuits 42c.

Thereafter, as in the third embodiment, the control unit 50, the microcomputer 43, and the calculation circuit 42c once become sleep states or off states. Then, at the determination timing after second or later polarization cancelation, in a state in which the control unit 50 and the microcomputer 43 are in the sleep state or the off state, the calculation circuit 42c wakes, and the third control unit 30 in the calculation circuit 42c controls the equalization discharge α3.

According to the present embodiment, the control of the equalization discharge α3 after first polarization cancelation and the calculation of the next determination timing can be quickly performed using the CPU, the ROM, the RAM, and the like of the control unit 50. In contrast, regarding the control of the equalization discharge α3 after second or later polarization cancelation and the calculation of the next determination timing, dark current can be suppressed as in the third embodiment.

It is noted that, although the present embodiment is based on the third embodiment, instead of this, the present embodiment may be based on the second embodiment. That is, in this case, the control of the equalization discharge α3 after first polarization cancelation and the calculation of the next determination timing are performed by the third control unit 30 in the control unit 50. The control of the equalization discharge α3 after second or later polarization cancelation and the calculation of the next determination timing are performed by the third control unit 30 in the microcomputer 43.

### OTHER EMBODIMENTS

The embodiments described above can be modified as below.

In the first to fourth embodiments, all of the equalization discharge α1 at charging time, the equalization discharge α2 during occurrence of polarization, and the setting of the cancellation determination time period t3 based on the state of the cell battery B are performed. Alternatively, only any one or two of these three may be performed.

In the first to fourth embodiments, regarding each of the cell batteries B, the difference obtained by subtracting the minimum cell voltage Vmin from the voltage of the cell battery B is referred to as a variation voltage ΔV of the cell battery B. Alternatively, the variation voltage ΔV may be corrected based on SOC or SOH (State of Health). Specifically, for example, regarding each of the cell batteries B, a voltage corresponding to the difference obtained by subtracting the SOC of the cell battery B, whose SOC is the smallest, from the SOC of the corresponding cell battery B may be referred to as the variation voltage ΔV of the corresponding cell battery B.

In the first to fourth embodiments, the external power supply 100 performs CC charge and CV charge for the battery pack 95. However, instead of CC charge or in addition to these, CP charge (constant power charge) may be performed. Then, the state determination unit 11 may determine, instead of whether it is during CC charge, whether it is during CP charge, or whether it is during CC charge or during CP charge. In addition, the equalization unit 13 may perform the equalization, instead of if it is determined to be during CC charge, if it is determined to be during CP charge, or if it is determined to be during CC charge or during CP charge.

In the first to fourth embodiments, the relaxation determination unit 21 sets the relaxation determination time period t2 based on all of the temperature, the SOHpw, and the SOC of the battery pack 95. Alternatively, the relaxation determination time period t2 may be set based on only any one or two of these three. The relaxation determination time period t2 may be a fixed value.

In the first to fourth embodiments, the variation determination unit 22 sets the determination voltage V2 during occurrence of polarization based on all of the temperature, the SOHpw, and the SOC of the battery pack 95. Alternatively, the determination voltage V2 during occurrence of polarization may be set based on only any one or two of these three. The determination voltage V2 during occurrence of polarization may be a fixed value.

In the first to fourth embodiments, the cancellation determination unit 31 sets the cancellation determination time period t3 based on all of the temperature, the SOHpw, and the SOC of the battery pack 95. Alternatively, the cancellation determination time period t3 may be set based on only any one or two of these three. The cancellation determination time period t3 may be a fixed value.

In the first to fourth embodiments, the next time setting unit 34 sets a time period until the next determination timing based on the variation voltage ΔV and the equalization current at the current determination timing. Alternatively, the time period until the next determination timing may be fixed.

In the first to fourth embodiments, the next time setting unit 34 sets a time period until the next determination timing based on the variation voltage ΔV and the equalization current. Instead of the equalization current, the next time setting unit 34 may set the time period until the next determination timing simply based on the magnitude of a resistance of the discharge path in the equalization discharge α3 of the cell battery B. That is, in this case, since the time period required for the equalization discharge α3 becomes longer as the magnitude of the resistance of the discharge path is higher, the next time setting unit 34 sets the time period until the next determination timing to be long.

In the first to fourth embodiments, the amount of charge of each of the cell batteries B is equalized by the equalization discharge α1 to α3. Alternatively, a cell battery B having a relatively small amount of charge may be charged by a cell battery B having a relatively large amount of charge to equalize the amount of charge of each of the cell batteries B.

In the first to fourth embodiments, the equalization current is a typical DC current. Alternatively, the equalization current may be a current having a waveform different from that of a typical DC current, such as a waveform in which a typical DC current is mixed with an AC waveform.

In the first to fourth embodiments, the battery pack 95 and the equalization devices 91 to 93 are installed in the electrically driven vehicle 90. Alternatively, the battery pack 95 and the equalization devices 91 to 93 may be installed in other equipment such as a drone.

The present disclosure has so far been described based on some embodiments. However, the present disclosure should not be construed as being limited to these embodiments or the structures. The present disclosure should encompass various modifications, or modifications within the range of equivalence. In addition, various combinations and modes, as well as other combinations and modes, including those which include one or more additional elements, or those which include fewer elements should be construed as being within the scope and spirit of the present disclosure.

An aspect of the present disclosure provides an equalization device (91 to 94) that performs equalization (α1 to α3) of amounts of charge of a plurality of cell batteries (B) included in a battery pack (95), the device including: a state determination unit (11) that determines whether it is in a predetermined charging state (whether a predetermined charging state is present) that includes at least one of a state in which the battery pack is subjected to constant current charge and a state in which the battery pack is subjected to constant power charge and does not include a state in which the battery pack is subjected to constant voltage charge; a charging time variation determination unit (12) that determines whether a variation voltage (ΔV) indicating a variation of a voltage of each of the cell batteries is higher than a predetermined charging time determination voltage (V1); and a charging time equalization unit (13) that performs the equalization (α1) if it is determined that it is in the predetermined charging state (if it is determined that the predetermined charging state is present) and that the variation voltage is higher than the charging time determination voltage.

According to the present disclosure, the equalization is performed not only after charging of the battery pack but also during charging. Hence, the time period during which the equalization can be performed can be prolonged by the added period, thereby increasing the ability to perform equalization.

Furthermore, the equalization is performed if it is determined to be during constant current charge or during constant power charge. During constant current charge or during constant power charge, since charging is controlled based of a current or power, high accuracy and a high frequency are not required for measuring voltage compared with a case during constant voltage charge during which charging is controlled based on voltage. Hence, during constant current charge and during constant power charge, even if the accuracy and frequency in measuring voltage are decreased due to the equalization, problems are not caused compared with the case during constant voltage charge.

As described above, according to the present disclosure, while adverse effects due to the decrease in accuracy and a frequency for measuring voltage due to the equalization is suppressed, the time period during which the equalization can be performed can be prolonged, thereby increasing the ability to perform equalization (current*time).

What is claimed is:

1. An equalization device that performs equalization of amounts of charge of a plurality of cell batteries included in a battery pack, the device comprising:
a state determination unit that determines whether it is in a predetermined charging state that includes at least one of a state in which the battery pack is subjected to constant current charge and a state in which the battery pack is subjected to constant power charge and does not include a state in which the battery pack is subjected to constant voltage charge;
a charging time variation determination unit that determines whether a variation voltage indicating a variation of a voltage of each of the cell batteries is higher than a predetermined charging time determination voltage; and
a charging time equalization unit that performs the equalization (α1) if it is determined that it is in the predetermined charging state and that the variation voltage is higher than the charging time determination voltage.

2. The equalization device according to claim 1, wherein
the state determination unit determines, during charging time of the battery pack, whether a margin voltage, which is obtained by subtracting a voltage of the cell battery of the battery pack having a highest voltage from a voltage at full charge time of the cell battery, is higher than a predetermined threshold margin voltage, and determines it to be the predetermined charging state if it is determined that the margin voltage is higher than the threshold margin voltage.

3. The equalization device according claim 1, wherein
the charging time variation determination unit sets a voltage value at least larger than a voltage error of the cell battery produced due to the equalization as the charging time determination voltage.

4. The equalization device according to claim 1, further comprising:
a relaxation determination unit that determines whether elapsed time from a charge end timing of the battery pack or elapsed time from a timing at which a main power switch of equipment in which the battery pack is installed is turned off is longer than a predetermined relaxation determination time period;
a polarization time variation determination unit that determines whether a variation voltage indicating variation of the voltage of each of the cell batteries is higher than a predetermined polarization time determination voltage;
a polarization time equalization unit that performs the equalization (α2) if it is determined that the elapsed time is longer than the relaxation determination time period and if it is determined that the variation voltage is higher than the polarization time determination voltage;
a cancellation determination unit that determines whether the elapsed time is longer than a cancellation determination time period longer than the relaxation determination time period;
a post-cancellation variation determination unit that determines whether the variation voltage is higher than a post-determination voltage lower than the polarization time determination voltage; and
a post-cancellation equalization unit that performs the equalization (α3) if it is determined that the elapsed time is longer than the cancellation determination time period and if it is determined that the variation voltage is higher than the post-determination voltage.

5. An equalization device that performs equalization of amounts of charge of a plurality of cell batteries included in a battery pack, the device comprising:
a relaxation determination unit that determines whether elapsed time from a charge end timing of the battery pack or elapsed time from a timing at which a main power switch of equipment in which the battery pack is installed is turned off is longer than a predetermined relaxation determination time period);
a polarization time variation determination unit that determines whether a variation voltage indicating a variation of a voltage of each of the cell batteries is higher than a predetermined polarization time determination voltage;
a polarization time equalization unit that performs the equalization (α2) if it is determined that the elapsed time is longer than the relaxation determination time period and if it is determined that the variation voltage is higher than the polarization time determination voltage;
a cancellation determination unit that determines whether the elapsed time is longer than a cancellation determination time period longer than the relaxation determination time period;
a post-cancellation variation determination unit that determines whether the variation voltage is higher than a post-cancellation determination voltage lower than the polarization time determination voltage; and
a post-cancellation equalization unit that performs the equalization (α3) if it is determined that the elapsed time is longer than the cancellation determination time period and if it is determined that the variation voltage is higher than the post-cancellation determination voltage.

6. The equalization device according to claim 4, wherein
the relaxation determination unit sets the relaxation determination time period based on at least a temperature of the battery pack and sets the relaxation determination time period to be lower in a case in which the temperature of the battery pack is higher than a predetermined temperature than in a case in which the temperature of the battery pack is lower than the predetermined temperature, or
a variable indicating that an internal resistance is lower as a value thereof is larger is defined as SOHpw, and the relaxation determination unit sets the relaxation determination time period based on at least the SOHpw of the battery pack and sets the relaxation determination time period to be lower in a case in which the SOHpw of the battery pack is larger than a predetermined value than in a case in which the SOHpw of the battery pack is smaller than the predetermined value.

7. The equalization device according to claim 4, wherein
the polarization time variation determination unit sets the polarization time determination voltage based on at least a temperature of the battery pack and sets the polarization time determination voltage to be lower in a case in which the temperature of the battery pack is higher than a predetermined temperature than in a case in which the temperature of the battery pack is lower than the predetermined temperature, or,
a variable indicating that an internal resistance is lower as a value thereof is larger is defined as SOHpw, and the polarization time variation determination unit sets the polarization time determination voltage based on at least the SOHpw of the battery pack and sets the polarization time determination voltage to be lower in a case in which the SOHpw of the battery pack is larger than a predetermined value than in a case in which the SOHpw of the battery pack is smaller than the predetermined value.

8. The equalization device according to claim 4, wherein
the cancellation determination unit sets the cancellation determination time period based on a state of the battery pack.

9. An equalization device that performs equalization of amounts of charge of a plurality of cell batteries included in a battery pack, the device comprising:
a cancellation determination unit that determines whether elapsed time from a charge end timing of the battery pack or elapsed time from a timing at which a main power switch of equipment in which the battery pack is installed is turned off is longer than a predetermined cancellation determination time period;
a post-cancellation variation determination unit that determines whether a variation voltage indicating a variation of a voltage of each of the cell batteries is higher than a predetermined post-cancellation determination voltage; and
a post-cancellation equalization unit that performs the equalization (α3) if it is determined that the elapsed time is longer than the cancellation determination time period and if it is determined that the variation voltage is higher than the post-cancellation determination voltage, wherein
the cancellation determination unit sets the cancellation determination time period based on a state of the battery pack.

10. The equalization device according to claim 8, wherein
the cancellation determination unit sets the cancellation determination time period based on at least a temperature of the battery pack and sets the cancellation determination time period to be shorter in a case in which the temperature of the battery pack is higher than a predetermined temperature than in a case in which the temperature of the battery pack is lower than the predetermined temperature, or
a variable indicating that an internal resistance is lower as a value thereof is larger is defined as SOHpw, and the cancellation determination unit sets the cancellation determination time period based on at least the SOHpw of the battery pack and sets the cancellation determination time period to be lower in a case in which the SOHpw of the battery pack is larger than a predetermined value than in a case in which the SOHpw of the battery pack is smaller than the predetermined value.

11. The equalization device according to claim 4, wherein
a timing, at which it is determined whether the equalization is performed by the cancellation determination unit, the post-cancellation variation determination unit, and the post-cancellation equalization unit, is set as a determination timing,
the equalization device further comprises a next time setting unit that sets a time period until a next determination timing, and
the next time setting unit sets a time period until the next determination timing based on at least the variation voltage at a current determination timing, and sets the time period until the next determination timing to be longer in a case in which the variation voltage at the current determination timing is higher than a predetermined value than in a case in which the variation voltage at the current determination timing is lower than the predetermined value.

12. The equalization device according to claim 11, wherein
the next time setting unit sets the time period until the next determination timing based on a magnitude of a resistance of a discharge path of the cell battery, and sets the time period until the next determination timing to be longer in a case in which the magnitude of the resistance of the discharge path is larger than a predetermined value than in a case in which the magnitude of the resistance of the discharge path is smaller than the predetermined value.

13. The equalization device according to claim 11, wherein
the next time setting unit measures an equalization current based on the voltage of the cell battery and the magnitude of the resistance of the discharge path of the cell battery or based on a voltage across terminals of a resistance through which a current flows due to the equalization and a magnitude of the resistance, and sets the time period until the next determination timing based on the equalization current and sets the time period until the next determination timing to be longer in a case in which the equalization current is lower than a predetermined value than in a case in which the equalization current is higher than the predetermined value.

14. The equalization device according to claim 11, further comprising measurement units that measure voltages of the respective cell batteries and a control unit that collects the voltages measured by the measurement units, wherein
in the measurement unit, the cancellation determination unit, the post-cancellation variation determination unit, the post-cancellation equalization unit, and the next time setting unit are provided, and
at the determination timing, in a state in which the control unit is in a sleep state or an off state, the cancellation determination unit, the post-cancellation variation determination unit, and the post-cancellation equalization unit in the measurement unit control the equalization, and the next time setting unit in the measurement unit sets the time period until the next determination timing.

15. The equalization device according to claim 14, wherein
the measurement unit includes a measurement circuit that measures the voltage of the cell battery and a microcomputer that controls the measurement circuit,
the measurement circuit includes a calculation circuit,
in the calculation circuit, the cancellation determination unit, the post-cancellation variation determination unit, the post-cancellation equalization unit, and the next time setting unit are provided, and
at the determination timing, in a state in which the microcomputer is in a sleep state or an off state, the cancellation determination unit, the post-cancellation variation determination unit, the post-cancellation equalization unit in the calculation circuit control the equalization, and the next time setting unit in the calculation circuit sets the time period until the next determination timing.
